(19) United States
(12) Patent Application Publication
(10) Pub. No.: US 2010/0205399 A1
(43) Pub. Date: Aug. 12, 2010

(54) PERFORMANCE COUNTER FOR MICROCODE INSTRUCTION EXECUTION

(75) Inventors: Brent Bean, Austin, TX (US); Jui-Shuan Chen, Austin, TX (US); G. Glenn Henry, Austin, TX (US); Terry Parks, Austin, TX (US)

Correspondence Address: HUFFMAN LAW GROUP, P.C., 1900 MESA AVE., COLORADO SPRINGS, CO, 80906, US

(73) Assignee: VIA TECHNOLOGIES, INC., Taipei (TW)

(21) Appl. No.: 12/370,586

(22) Filed: Feb. 12, 2009

(51) Int. Cl. G06F 9/32

(52) U.S. Cl. 712/36; 712/E09.073

(57) ABSTRACT

An apparatus for counting microcode instruction execution in a microprocessor includes a first register, a second register, a comparator, and a counter. The first register stores an address of a microcode instruction. The microcode instruction is stored in a microcode memory of the microprocessor. The second register stores an address of the next microcode instruction to be retired by a retire unit of the microprocessor. The comparator compares the addresses stored in the first and second registers to indicate a match between them. The counter counts the number of times the comparator indicates a match between the addresses stored in the first register and the second register. The first register is user-programmable and the counter is user-readable. A mask register may be included to create a range of microcode memory addresses so that executions of microcode instructions within the range are counted.

### FIELD OF THE INVENTION

The present invention relates in general to microprocessors, and more particularly to counting microcode instruction executions within a microprocessor.

### BACKGROUND OF THE INVENTION

Many modern microprocessors include microcode instruction sequences, or microcode, that implements complex and/or infrequently executed instructions of the microprocessor instruction set. A microcode memory within the microprocessor includes multiple microcode instruction sequences. When the microprocessor decodes one of the microcode-implemented instructions of the instruction set, rather than sending the instruction directly to the execution units of the microprocessor to be executed, the microprocessor transfers control to the appropriate microcode routine in the microcode ROM. The microprocessor then sends the microcode instructions to the execution units that execute the instructions to implement the complex and/or infrequently executed instruction. This allows the execution units (and other units of the microprocessor, such as a dependency checking unit or retire unit) to be less complex than they would be if they had to be capable of executing all the instructions of the microprocessor instruction set, including even the complex and/or infrequently executed instructions.

Like other programs, microcode must be debugged. Furthermore, like other programs, it is desirable to optimize the performance of microcode, particularly since good performing microcode will likely improve the overall performance of programs that include microcode-implemented instructions of the microprocessor instruction set. However, because the microcode is within the microprocessor itself, unlike the fetching of user program instructions, typically the fetching of microcode instructions is not directly visible on the external pins of the microprocessor. This makes debugging and performance measurement of microcode more difficult than user programs. Furthermore, although microprocessors commonly provide debugging and performance measurement facilities for user programs (see, for example, Chapter 18 of the IA-32 Intel Architecture Software Developer's Manual, Volume 3B: System Programming Guide, Part 2, June 2006), they do not provide these facilities for microcode.

Therefore, what is needed is an aid in debugging and measuring performance of microcode.

### BRIEF SUMMARY OF INVENTION

The present invention provides an apparatus for counting microcode instruction execution in a microprocessor. The apparatus includes a first register, configured to store an address of a microcode instruction. The microcode instruction is stored in a microcode memory of the microprocessor. The apparatus includes a second register, configured to store an address of the next microcode instruction to be retired by a retire unit of the microprocessor. The apparatus includes a comparator, coupled to the first and second registers, configured to indicate a match between the addresses stored in the first and second registers. The apparatus includes a counter, coupled to the comparator, configured to count the number of times the comparator indicates a match between the addresses stored in the first register and the second register.

In one aspect, the present invention provides a method for counting microcode instruction execution in a microprocessor. The method includes storing to a first register an address of a microcode instruction stored in a microcode memory of the microprocessor. The method also includes storing to a second register an address of the next microcode instruction to be retired by a retire unit of the microprocessor. The method also includes comparing the addresses stored in the first register and the second register to determine whether a match occurs between the addresses stored in the first and second registers. The method also includes counting the number of times a match occurs between the addresses stored in the first register and the second register.

In another aspect, the present invention provides a computer program product for use with a computing device. The computer program product includes a computer usable storage medium, having computer readable program code embodied in said medium, for specifying an apparatus for counting microcode instruction execution in a microprocessor. The computer readable program code includes first program code for specifying a first register, configured to store an address of a microcode instruction, wherein the microcode instruction is stored in microcode memory of the microprocessor. The computer readable program code includes second program code for specifying a second register, configured to store an address of the next microcode instruction to be retired by a retire unit of the microprocessor. The computer readable program code includes third program code for specifying a comparator, coupled to the first and second registers, configured to indicate a match between the addresses stored in the first and second registers. The computer readable program code includes fourth program code for specifying a counter, coupled to the comparator, configured to count the number of times the comparator indicates a match between the addresses stored in the first register and the second register.

An advantage of the present invention is that it provides instrumentation for counting microcode execution in real time, without specialized external tools or probes into internal functions of a microprocessor. Therefore, microcode execution measurements can be made outside of a lab environment, such as in an end user installation for remote debug or performance measurement.

Another advantage of the present invention is that it provides a way to measure microcode execution without impacting the actual execution of user programs executing on the microprocessor that include microcode-implemented instructions. The overhead required to commence measuring microcode execution and to subsequently obtain the measurements are a small number of writes/reads to/from control registers.

### BRIEF DESCRIPTION OF THE DRAWINGS

FIG. 1 is a block diagram illustrating a microprocessor according to the present invention.

FIG. 2 is a flowchart illustrating operation of the microprocessor 100 of FIG. 1 according to the present invention.

FIG. 3 is a block diagram illustrating a microprocessor according to an alternate embodiment of the present invention.

### DETAILED DESCRIPTION OF THE INVENTION

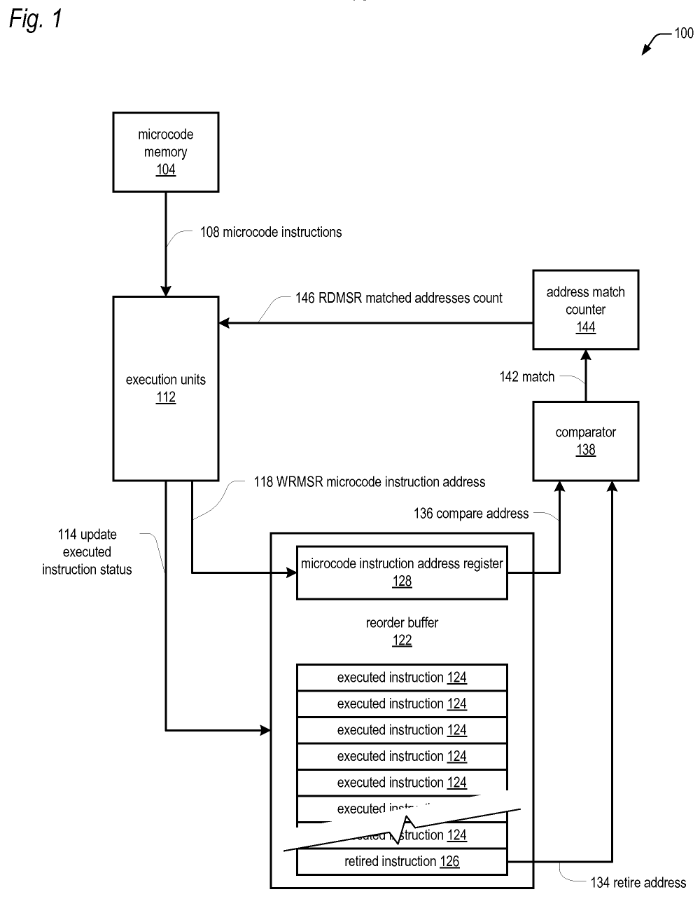

Referring to FIG. 1, a block diagram illustrating a microprocessor 100 according to the present invention is shown. Microcode memory 104 stores microcode instructions 108 that are provided by the microcode memory 104 to execution units 112 in response to microprocessor 100 receiving user program instructions. Although not shown, microinstructions from the other sources are also provided to the execution units 112 for execution, such as from an instruction translator or instruction cache (not shown) of the microprocessor 100. In one embodiment, the execution units 112 execute microinstructions in an out of order fashion.

The microprocessor 100 also includes a reorder buffer 122 coupled to the execution units 112. The microprocessor 100 allocates an entry 124/126 in the reorder buffer 122 for each microinstruction issued to the execution units 112, such as microcode instructions 108. Along with each microcode instruction 108, the microprocessor 100 provides to the reorder buffer 122 the address of the microcode instruction 108 in the microcode memory 104 and an indication that the microcode instruction 108 was supplied by the microcode memory 104 rather than from another instruction source. After the execution units 112 execute microinstructions, they update the status 114 of the executed microinstructions within the reorder buffer 122. This enables the reorder buffer 122 to insure that microinstructions are retired in program order. Specifically, each clock cycle, the reorder buffer 122 checks the status 114 of the oldest microinstruction therein to see whether it has completed execution and is therefore ready to be retired, shown in FIG. 1 as the microinstruction in entry 126.

The reorder buffer 122 also contains a microcode instruction address register 128. The microcode instruction address register 128 stores the address of a microcode instruction 108 in microcode memory 104 for which it is desired to measure the number of times the microcode instruction 108 is executed. The microcode instruction address register 128 is writeable by a user program. In one embodiment, when a program executes a write MSR (WRMSR) instruction, the execution units 112 write a microcode instruction address 118 specified by the WRMSR instruction to the microcode instruction address register 128.

A comparator 138 compares a compare address 136 provided from the microcode instruction address register 128 with a retire address 134 provided from the retired instruction entry 126 of the reorder buffer 122 to determine if the address of the microinstruction being retired matches the microcode memory address 136 programmed into the microcode instruction address register 128. The comparator 138 produces a positive match 142 if the compare address 136 is the same as the retire address 134, and produces a negative match 142 if the compare address 136 is not the same as the retire address 134. An address match counter 144 increments its current count every time it receives a positive match 142. In this way, the address match counter 144 stores a count equal to the number of times a microcode instruction 108 at a location in microcode memory 104 specified by the compare address 136 is retired. In one embodiment, the address match counter 144 is incremented if it receives a positive match 142 only if the above-mentioned indication indicates that the retired microinstruction 126 was sourced by the microcode memory 104. In one embodiment, the reorder buffer 122 capable of retiring the oldest N microinstructions 126 in the reorder buffer 122, where N is design dependent. In one embodiment, up to three microinstructions 126 are retired at the same time, thus generating N retire addresses 134. In such an embodiment, the reorder buffer 122 includes N comparators 138, each configured to compare a respective retire address 134 with the compare address 136. If any of the comparators 138 generates a positive value, the counter 144 increments its count.

The address match counter 144 provides its count 146 to the execution units 112. In one embodiment, a user program executes a read MSR (RDMSR) instruction to read the matched addresses count 146 from the counter 144. In one embodiment, the address match counter 144 is initialized to a count value of zero when the microcode instruction address 118 is programmed into the microcode instruction address register 128.

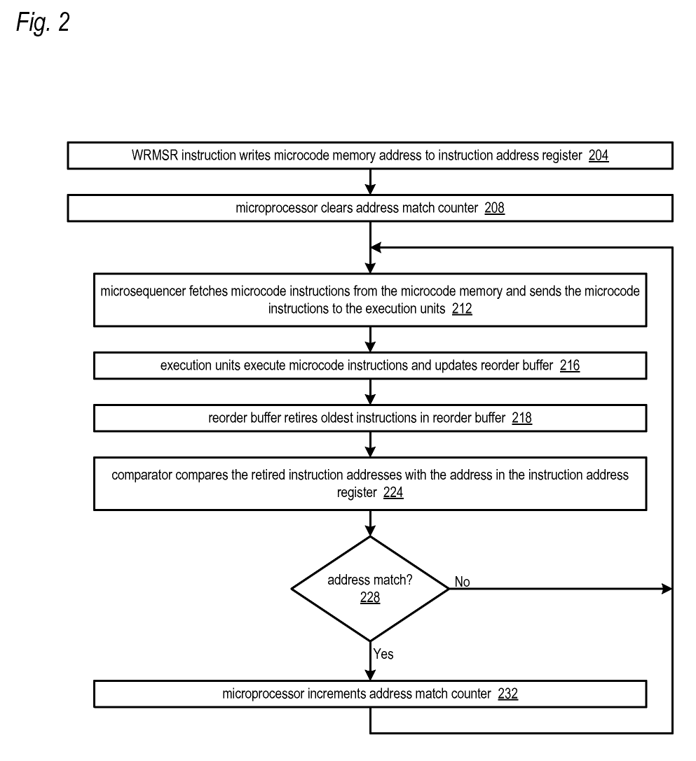

Referring now to FIG. 2, a flowchart illustrating operation of the microprocessor 100 of FIG. 1 according to the present invention is shown. Flow begins at block 204.

At block 204, a write MSR (WRMSR) instruction writes a microcode instruction address 118 to the microcode instruction address register 128. The microcode instruction address 118 is the address of an instruction in microcode memory 104. It is desired to count how many times the instruction at the microcode instruction address 118 is executed by the microprocessor 100. The WRMSR instruction may be part of a user program. Flow proceeds to block 208.

At block 208, in response to the write MSR (WRMSR) instruction writing a microcode instruction address 118 to the microcode instruction address register 128 in block 204, the microprocessor 100 clears the address match counter 144. Clearing the address match counter 144 initializes the count to a zero value. Flow proceeds to block 212.

At block 212, a microsequencer of a microcode unit (not shown) of microprocessor 100 fetches microcode instructions 108 from the microcode memory 104 and sends the microcode instructions 108 to the execution units 112. Flow proceeds to block 216.

At block 216, the execution units 112 execute the microcode instructions 108 and subsequently update the status 114 of the executed microinstructions in their associated entries 124/126 of the reorder buffer 122. Flow proceeds to block 218.

At block 218, the reorder buffer 122 retires the oldest microinstruction 126 in reorder buffer 122. In one embodiment, the reorder buffer 122 can simultaneously retire a plurality of microinstructions 126, as discussed above. Flow proceeds to block 224.

At block 224, the comparator 138 compares the retire address 134 of the retired microinstruction 126 with the compare address 136 in the microcode instruction address register 128 to generate the match signal 142 to indicate whether the address 134 of the retiring microinstruction 106 is the same as the compare address 136 in instruction address register 128. Flow proceeds to decision block 228.

At decision block 228, if the addresses compared at block 224 match, flow proceeds to block 232; otherwise, flow proceeds to block 212 where the process is repeated.

At block 232, the microprocessor 100 increments the address match counter 144, in response to receiving a positive match 142 from the comparator 138. Flow proceeds to block 212, where the process is repeated.

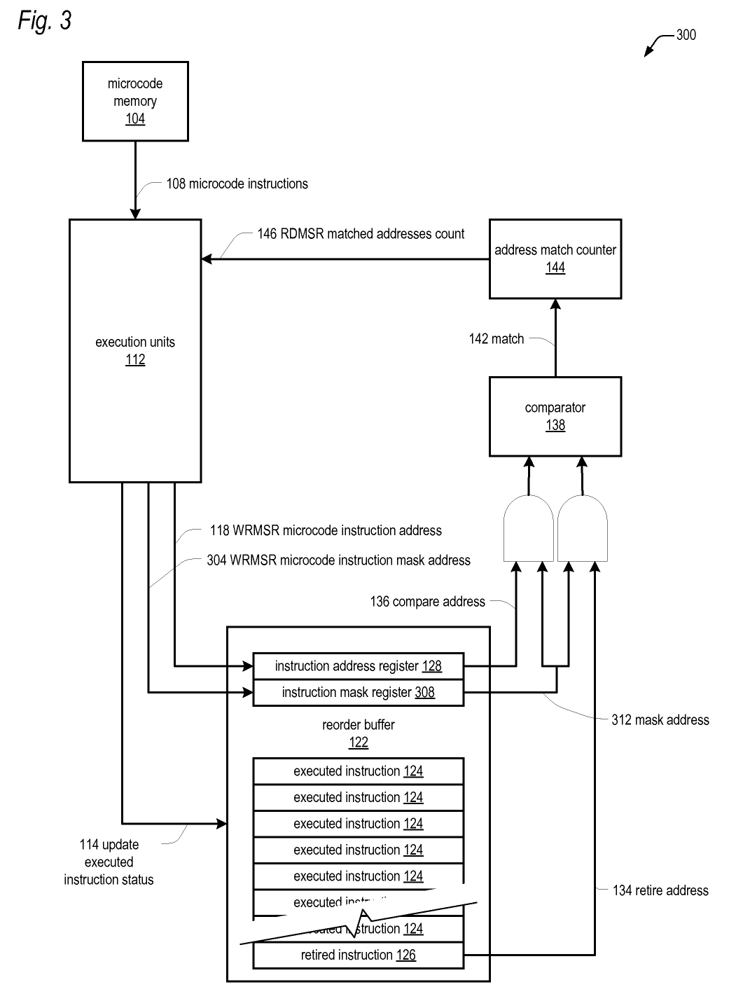

Referring now to FIG. 3, a block diagram illustrating a microprocessor 300 according to an alternate embodiment of the present invention is shown. The embodiment shown in FIG. 3 is similar to the embodiment shown in FIG. 1 and like-numbered elements are similar. Differences between the embodiment of FIG. 3 and the embodiment of FIG. 1 will now be described.

In the embodiment of FIG. 3, the reorder buffer 122 contains an instruction mask register 308. The instruction mask register 308 stores an address mask 312 that is used to mask off bits of the compare address 136 and the retire address 134 before being compared by the comparator 138. The consequence is that a positive match 142 indicates that a microcode instruction 108 was retired whose microcode memory 104 address is within a range of addresses specified by the combination of the compare address 136 and the address mask 312, rather than indicating that a microcode instruction 108 was retired whose microcode memory 104 address matches a particular address of the microcode memory 104 as with the embodiment of FIG. 1.

The instruction mask register 308 is writeable by a user program. In one embodiment, when a program executes a WRMSR instruction, the execution units 112 write an instruction mask address 304 specified by the WRMSR instruction to the instruction mask register 308.

Although embodiments have been described in which the counter measures the actual execution of microcode instructions, other embodiments are contemplated in which the counter 144 measures the fetching of microcode instruction from the microcode memory 104, which may be different from the actual execution thereof, such as due to speculative execution by the microprocessor 100. Additionally, although embodiments are described that include a single microcode instruction address register 128, comparator 138, and address match counter 144, other embodiments are contemplated in which the microprocessor 100 includes multiple of these elements to enable counting executions of more than one microcode instruction within the microcode memory 104.

While various embodiments of the present invention have been described herein, it should be understood that they have been presented by way of example, and not limitation. It will be apparent to persons skilled in the relevant computer arts that various changes in form and detail can be made therein without departing from the scope of the invention. For example, software can enable, for example, the function, fabrication, modeling, simulation, description and/or testing of the apparatus and methods described herein. This can be accomplished through the use of general programming languages (e.g., C, C++), hardware description languages (HDL) including Verilog HDL, VHDL, and so on, or other available programs. Such software can be disposed in any known computer usable medium such as semiconductor, magnetic disk, or optical disc (e.g., CD-ROM, DVD-ROM, etc.). Embodiments of the apparatus and method described herein may be included in a semiconductor intellectual property core, such as a microprocessor core (e.g., embodied in HDL) and transformed to hardware in the production of integrated circuits. Additionally, the apparatus and methods described herein may be embodied as a combination of hardware and software. Thus, the present invention should not be limited by any of the herein-described exemplary embodiments, but should be defined only in accordance with the following claims and their equivalents. Specifically, the present invention may be implemented within a microprocessor device which may be used in a general purpose computer. Finally, those skilled in the art should appreciate that they can readily use the disclosed conception and specific embodiments as a basis for designing or modifying other structures for carrying out the same purposes of the present invention without departing from the scope of the invention as defined by the appended claims.

We claim:

1. An apparatus for counting microcode instruction execution in a microprocessor, the apparatus comprising:
a first register, configured to store an address of a microcode instruction stored within a microcode memory of the microprocessor;
a second register, configured to store an address of the next microcode instruction to be retired by a retire unit of the microprocessor;
a comparator, coupled to the first and second registers, configured to indicate a match between the addresses stored in the first and second registers; and
a counter, coupled to the comparator, configured to count the number of times the comparator indicates a match between the addresses stored in the first register and the second register.

2. The apparatus of claim 1, wherein the first register is user-programmable.

3. The apparatus of claim 1, wherein the first register is programmable by a write model-specific register (WRMSR) instruction.

4. The apparatus of claim 1, wherein the counter is readable by a user program.

5. The apparatus of claim 1, wherein the counter is readable by a read model-specific register (RDMSR) instruction.

6. The apparatus of claim 1, wherein the microcode instruction is a non-user program instruction.

7. The apparatus of claim 1, wherein the microcode memory is in an address space that is non-accessible by user programs.

8. The apparatus of claim 1, wherein the counter counts only if the next microcode instruction to be retired indicates it was sourced from the microcode memory.

9. The apparatus of claim 1, further comprising:
a mask register, coupled to the first and second registers, configured to store a mask value, wherein the mask value is used in combination with the address stored in the second register to specify a range of addresses in the microcode memory;
wherein the comparator is configured to indicate a match when the address of the next microcode instruction to be retired falls within the range of addresses.

10. The apparatus of claim 9, wherein the mask register is user-programmable.

11. The apparatus of claim 1, wherein the counter is reset when an address is stored in the first register.

12. A method for counting microcode instruction execution in a microprocessor, the method comprising:
storing to a first register an address of a microcode instruction stored in a microcode memory of the microprocessor;
storing to a second register an address of the next microcode instruction to be retired by a retire unit of the microprocessor;
comparing the addresses stored in the first register and the second register to determine whether a match occurs between the addresses stored in the first and second registers; and
counting the number of times a match occurs between the addresses stored in the first register and the second register.

13. The method of claim 12, wherein the first register is user-programmable.

14. The method of claim 12, wherein the first register is programmable by a write model-specific register (WRMSR) instruction.

15. The method of claim 12, wherein the number of times is readable by a user program.

16. The method of claim 12, wherein the number of times is readable by a read model-specific register (RDMSR) instruction.

17. The method of claim 12, wherein the microcode instruction is a non-user program instruction.

18. The method of claim 12, wherein the microcode memory is in an address space that is non-accessible by user programs.

19. The method of claim 12, wherein said counting is performed only if the next microcode instruction to be retired indicates it was sourced from the microcode memory.

20. The method of claim 12, further comprising:
storing a mask value into a mask register;
using the mask value in combination with the address stored in the second register to specify a range of addresses in the microcode memory;
determining whether the address of the next microcode instruction to be retired falls within the range of addresses; and
counting the number of times the address of the next microcode instruction to be retired falls within the range of addresses.

21. The method of claim 20, wherein the mask register is user-programmable.

22. The method of claim 12, further comprising:
resetting the number of times, in response to said storing to the first register the address of the microcode instruction.

23. A computer program product for use with a computing device, the computer program product comprising:
a computer usable storage medium, having computer readable program code embodied in said medium, for specifying an apparatus for counting microcode instruction execution in a microprocessor, the computer readable program code comprising:
first program code for specifying a first register, configured to store an address of a microcode instruction, wherein the microcode instruction is stored in microcode memory of the microprocessor;
second program code for specifying a second register, configured to store an address of the next microcode instruction to be retired by a retire unit of the microprocessor;
third program code for specifying a comparator, coupled to the first and second registers, configured to indicate a match between the addresses stored in the first and second registers; and
fourth program code for specifying a counter, coupled to the comparator, configured to count the number of times the comparator indicates a match between the addresses stored in the first register and the second register.
